(19) United States
(12) Patent Application Publication
(10) Pub. No.: US 2023/0348813 A1
(43) Pub. Date: Nov. 2, 2023

(54) REMOVAL OF UNWANTED MINERAL OIL HYDROCARBONS

(71) Applicant: CARGILL, INCORPORATED, Wayzata, MN (US)

(72) Inventor: Gijsbertus Johannes Netherlands, Spijkenisse (NL)

(73) Assignee: CARGILL, INCORPORATED, Wayzata, MN (US)

(21) Appl. No.: 18/040,052

(22) PCT Filed: Jul. 28, 2021
(86) PCT No.: PCT/US2021/043485

§ 371 Date: Jan. 31, 2023

(30) Foreign Application Priority Data
Aug. 11, 2020 (EP) 20190409.1
Apr. 19, 2021 (EP) 21169092.0

(51) Int. Cl. C11B 3/12; A23D 9/04; A23L 5/20; B01D 1/22; B01D 3/34

(52) U.S. Cl. CPC C11B 3/12; A23D 9/04; A23L 5/21; B01D 1/22; B01D 3/343

(57) ABSTRACT

Present invention relates to a process for reducing the content of MOSH and/or MOAH from vegetable liquid oil, wherein the process is comprising the step of subjecting vegetable liquid oil to a short-path evaporation, wherein the short-path evaporation is performed at a pressure of below 1 mbar, at an evaporator temperature in a range of from 200° C. to 300° C., and with a feed rate per unit area of evaporator surface of the shorth-path evaporation equipment in a range of from 30 to 220 kg/h·m². Present invention further relates to the use of short-path evaporation performed at a pressure below 1 mbar, at an evaporator temperature of from 200 to 300° C., and a feed rate per unit area of evaporator surface of the shorth-path evaporation equipment in a range of from 30 to 220 kg/h·m², for reducing the content of MOSH and/or MOAH from vegetable liquid oil.

This application claims the benefit of European Provisional Application No. 20190409.1, filed Aug. 11, 2020, and European Provisional Application No. 21169092.0, filed Apr. 19, 2021 which are incorporated by reference herein in its entirety.

### FIELD OF THE INVENTION

The present invention relates to a novel process for reducing the content of MOSH and/or MOAH in vegetable liquid oils.

### BACKGROUND OF THE INVENTION

Mineral Oil Hydrocarbons (MOH) may be present as contaminants in oils and fat as well in foods prepared thereof. MOH are a complex mixture of molecules that are usually categorized into two main groups: Mineral Oil Saturated Hydrocarbons (MOSH) and Mineral Oil Aromatic Hydrocarbons (MOAH). MOSH are linear and branched alkanes and/or cyclo-alkanes. MOAH consists of highly alkylated mono- and/or polycyclic aromatic hydrocarbons.

Contamination of food and feed products with MOH may occur through migration from materials in contact with food such as plastic materials, like polypropylene or polyethylene, recycled cardboard and jute bags. Contamination also occurs from the use of mineral oil-based food additives or processing aids and from unintentional contamination like for example from lubricants or exhaust gases from combustion engines.

From a health perspective, it is desirable to reduce, or even completely remove, MOSH and MOAH contamination from edible vegetable oils.

Crude oils, as extracted from their original source, are not suitable for human consumption due the presence of impurities—such as free fatty acids, phosphatides, metals and pigments—which may be harmful or may cause an undesirable colour, odour or taste. Crude oils are therefore refined before use. The refining process typically consists of three major steps: degumming, bleaching and deodorizing. Optionally, a fourth step of chemical refining is included. An oil obtained after completion of the refining process (called a “refined oil” or more specifically a deodorized oil) is normally considered suitable for human consumption and may therefore be used in the production of any number of foods and beverages.

Unfortunately, existing refining processes are not effective to remove MOSH and/or MOAH. There is a need in the industry to identify an efficient and effective method for reducing MOSH and/or MOAH levels in vegetable oils. The present invention provides such a process.

### SUMMARY OF THE INVENTION

The present invention relates to a process for reducing the content of MOSH and/or MOAH from a vegetable liquid oil, wherein the process is comprising the step of subjecting a vegetable liquid oil to a short-path evaporation, wherein the short-path evaporation is performed at a pressure of below 1 mbar, at an evaporator temperature in a range of from 200° C. to 300° C., and with a feed rate per unit area of evaporator surface of the shorth-path evaporation equipment in a range of from 30 to 220 kg/h·m², and thus obtaining a retentate vegetable liquid oil and a distillate.

The present invention further relates to the use of short-path evaporation performed at a pressure below 1 mbar, at an evaporator temperature of from 200 to 300° C., and a feed rate per unit area of evaporator surface of the shorth-path evaporation equipment in a range of from 30 to 220 kg/h·m², for reducing the content of MOSH and/or MOAH from a vegetable liquid oil.

### DETAILED DESCRIPTION

The present invention relates to a process for reducing the content of MOSH and/or MOAH from a vegetable liquid oil, wherein the process is comprising the step of subjecting a vegetable liquid oil to a short-path evaporation, wherein the short-path evaporation is performed at a pressure of below 1 mbar, at an evaporator temperature in a range of from 200° C. to 300° C., and with a feed rate per unit area of evaporator surface of the shorth-path evaporation equipment in a range of from 30 to 220 kg/h·m², and thus obtaining a retentate vegetable liquid oil and a distillate.

### Vegetable Oil as Starting Material

The term “vegetable liquid oil” is encompassing vegetable oils having melting point of 20° C. or less. The vegetable liquid oil that is subjected to the short-path evaporation of the process of the invention may be derived from one or more vegetable sources and may include oils from a single origin, or blends of two or more oils from different sources or with different characteristics. The vegetable liquid oil may be oils that are occurring in nature and/or that have been further subjected to a refining process, such as, but not limited to, degumming, bleaching, and/or deodorization. The vegetable liquid oil may be also be derived from oils and/or fats that have been subjected to a process for modifying the structure of the oils and/or fats, such as, but not limited to, fractionation, interesterification or a combination two or more processes.

The vegetable liquid oils have a molecular weight of more than 870 g/mol, or more than 880 g/mol.

The vegetable liquid oil that is subjected to the short-path evaporation of the process of the invention is selected from the group consisting of sunflower oil, high- or mid-oleic sunflower oil, rapeseed oil, linseed oil, cottonseed oil, soybean oil, groundnut oil, olive oil, camelina oil or any combination of two or more thereof. Preferably, the vegetable liquid oil is selected from the group consisting of sunflower oil, high- or mid-oleic sunflower oil, rapeseed oil, cottonseed oil, soybean oil or two or more thereof.

In one aspect of the invention, the vegetable liquid oil that is subjected to the short-path evaporation of the process is a degummed, bleached and/or deodorized vegetable liquid oil. Preferably the vegetable liquid oil is at least degummed.

Crude vegetable liquid oil may be subjected to one or more degumming steps. Any of a variety of degumming processes known in the art may be used. One such process (known as “water degumming”) includes mixing water with the oil and separating the resulting mixture into an oil component and an oil-insoluble hydrated phosphatides component, sometimes referred to as “wet gum” or “wet lecithin”. Alternatively, phosphatide content can be reduced (or further reduced) by other degumming processes, such as acid degumming (using citric or phosphoric acid for instance), enzymatic degumming (e.g., ENZYMAX from Lurgi) or chemical degumming (e.g., SUPERIUNI degumming from Unilever or TOP degumming from VandeMoortele/Dijkstra CS). Alternatively, phosphatide content can also be reduced (or further reduced) by means of acid conditioning, wherein the oil is treated with acid in a high shear mixer and is subsequently sent without any separation of the phosphatides to the bleaching step.

The bleaching step in general is a process step whereby impurities are removed to improve the color and flavor of the oil. It is typically performed prior to deodorization. The nature of the bleaching step will depend, at least in part, on the nature and quality of the oil being bleached. Generally, a crude or partially refined oil will be mixed with a bleaching agent which combines, amongst others, with oxidation products, phosphatides, trace soaps, pigments and other compounds to enable their removal. The nature of the bleaching agent can be selected to match the nature of the crude or partially refined oil to yield a desirable bleached oil. Bleaching agents generally include natural or “activated” bleaching clays, also referred to as “bleaching earths”, activated carbon and various silicates. Natural bleaching agent refers to non-activated bleaching agents. They occur in nature or they occur in nature and have been cleaned, dried, milled and/or packed ready for use. Activated bleaching agent refers to bleaching agents that have been chemically modified, for example by activation with acid or alkali, and/or bleaching agents that have been physically activated, for example by thermal treatment. Activation includes the increase of the surface in order to improve the bleaching efficiency. Further, bleaching clays may be characterized based on their pH value. Typically, acid-activated clays have a pH value of 2.0 to 5.0. Neutral clays have a pH value of 5.5 to 9.0. A skilled person will be able to select a suitable bleaching agent from those that are commercially available based on the oil being refined and the desired end use of that oil.

The bleaching step for obtaining the degummed and bleached vegetable liquid oil that is subjected to the short-path evaporation of the process, is performed at a temperature of from 80 to 115° C., from 85 to 110° C., or from 90 to 105° C., in presence of neutral and/or natural bleaching earth in an amount of from 0.2 to 5%, from 0.5 to 3%, or from 0.7 to 1.5% based on amount of oil.

Deodorization is a process whereby free fatty acids (FFAs) and other volatile impurities are removed by treating (or “stripping”) a crude or partially refined oil under vacuum and at elevated temperature with sparge steam, nitrogen or other gasses. The deodorization process and its many variations and manipulations are well known in the art and the deodorization step of the present invention may be based on a single variation or on multiple variations thereof.

For instance, deodorizers may be selected from any of a wide variety of commercially available systems (such as those sold by Krupp of Hamburg, Germany; De Smet Group, S.A. of Brussels, Belgium; Gianazza Technology s.r.l. of Legnano, Italy; Alfa Laval AB of Lund, Sweden Crown Ironworks of the United States, or others). The deodorizer may have several configurations, such as horizontal vessels or vertical tray-type deodorizers.

Deodorization is typically carried out at elevated temperatures and reduced pressure to better volatilize the FFAs and other impurities. The precise temperature and pressure may vary depending on the nature and quality of the oil being processed. The pressure, for instance, will preferably be no greater than 10 mm Hg but certain aspects of the invention may benefit from a pressure below or equal to 5 mm Hg, e.g. 1-4 mm Hg. The temperature in the deodorizer may be varied as desired to optimize the yield and quality of the deodorized oil. At higher temperatures, reactions which may degrade the quality of the oil will proceed more quickly. For example, at higher temperatures, cis-fatty acids may be converted into their less desirable trans form. Operating the deodorizer at lower temperatures may minimize the cis-to-trans conversion, but will generally take longer or require more stripping medium or lower pressure to remove the requisite percentage of volatile impurities. As such, deodorization is typically performed at a temperature of the oil in a range of 200 to 280° C., with temperatures of about 220-270° C. being useful for many oils. Typically, deodorization is thus occurring in a deodorizer whereby volatile components such as FFAs and other unwanted volatile components that may cause off-flavors in the oil, are removed. Deodorization may also result in the thermal degradation of unwanted components.

The deodorization step for obtaining the degummed, bleached and deodorized vegetable liquid oil that is subjected to the short-path evaporation of the process, is performed at a temperature of from 200° C. to 270° C., from 210° C. to 260° C., or from 220° C. to 250° C. The deodorization step is taking place for a period of time from 30 min to 240 min, from 45 min to 180 min, or from 60 min to 150 min.

The deodorization step for obtaining the degummed, bleached and deodorized vegetable liquid oil that is subjected to the short-path evaporation of the process, is performed in the presence of sparge steam in a range of from 0.50 to 2.50 wt %, from 0.75 to 2.00 wt %, from 1.00 to 1.75 wt %, or from 1.25 to 1.50 wt % based on amount of oil, and at an absolute pressure of 10 mbar or less, 7 mbar or less, 5 mbar or less, 3 mbar or less, 2 mbar or less.

Typically, a degummed, bleached and deodorized vegetable edible oil is known to be obtained by means of 2 major types of refining processes, i.e. a chemical or a physical refining process. The chemical refining process may typically comprise the major steps of degumming, alkali refining, also called neutralization, bleaching and deodorizing. The thus obtained deodorized oil is a chemically refined oil, also called “NBD” oil. Alternatively, the physical refining process may typically comprise the major steps of degumming, bleaching and deodorizing. A physically refining process is not comprising an alkali neutralization step as is present in the chemical refining process. The thus obtained deodorized oil is a physically refined oil, also called “RBD” oil.

The vegetable liquid oil that is subjected to the short-path evaporation of the process is a degummed, bleached and deodorized vegetable liquid oil and a method for obtaining the degummed, bleached and deodorized vegetable liquid oil is comprising the steps of:
i) Degumming and obtaining a degummed vegetable liquid oil,
ii) Optionally alkali neutralizing the degummed vegetable liquid oil from step i),
iii) Bleaching the degummed oil from step i) or the alkali neutralized oil from step ii)
   at a temperature of from 80 to 115° C., from 85 to 110° C., or from 90 105° C.,
   with neutral and/or natural bleaching earth in an amount of from 0.2 to 5%, from 0.5 to 3%, or from 0.7 to 1.5%, and obtaining a degummed and bleached oil, and
iv) Deodorizing the degummed, optionally alkali neutralized, and bleached oil from step iii)
   at a temperature of from 200 to 270° C., from 210 to 260° C., or from 220 to 250° C.,
   for a period of time in a range of from 30 min to 240 min, from 45 min to 180 min, or from 60 min to 150 min.

The vegetable liquid oil that is subjected to the short-path evaporation may have a content of MOSH of 20 ppm or higher, 40 ppm or higher, 60 ppm or higher, or even 80 ppm or higher. The content of MOAH may be more than 5 ppm or higher, more than 10 or higher, more than 20 ppm or higher, more than 40 ppm or higher, or even more than 60 ppm or higher.

### Short-Path Evaporation

Short-path evaporation, also called short-path distillation or molecular distillation, is a distillation technique that involves the distillate travelling a short distance, often only a few centimetres, and it is normally done at reduced pressure. With short path distillation, a decrease of boiling temperature is obtained by reducing the operating pressure. It is a continuous process with very short residence time. This technique is often used for compounds which are unstable at high temperatures or to purify small amounts of compounds. The advantage is that the heating temperature can be considerably lower (at reduced pressure) than the boiling point of the liquid at standard pressure. Additionally, short-path evaporation allows working at very low pressure.

Different types of short-path evaporation apparatus can be used that are well known to the skilled person. Examples are, but are not limited to, falling film, centrifugal, or wiped film evaporation apparatus. Preferably the short-path evaporation of the current process is performed in a wiped film evaporation apparatus.

The short-path evaporation is performed at a pressure below 1 mbar, preferably below 0.05 mbar, more preferably below 0.01 mbar, most preferably below 0.001 mbar.

The short-path evaporation is further performed at specific conditions of evaporator temperature and feed rate per unit area of evaporator surface of the shorth-path evaporation equipment.

The “feed rate per unit area of evaporator surface of the shorth-path evaporation equipment”, also called “specific throughput” or “specific feed rate”, expressed in kg/h·m², is defined as the flow of oil, expressed in kg/h, per unit area of evaporator surface of the short-path evaporation equipment, expressed in m². The feed rate per unit area of evaporator surface of the shorth-path evaporation equipment in the process of the current invention is applicable to any short-path equipment, including industrial short-path evaporation equipment independent of the dimensions of the equipment. Preferably stainless steel short-path evaporation equipment is used in the current invention.

In one aspect of the invention, the short-path evaporation of the current process is performed at an evaporator temperature in a range of from 200° C. to 300° C., from 210 to 290° C., from 220 to 280° C., or from 230° C. to 270° C. and with a feed rate per unit area of evaporator surface of the shorth-path evaporation equipment in a range of from 30 to 220 kg/h·m², from 50 to 200 kg/h·m², or from 70 to 180 kg/h·m².

In the process according to the invention, two fractions are obtained from the short-path evaporation: a retentate vegetable liquid oil and a distillate.

The process according to the invention results in a retentate vegetable liquid oil having a reduced content of MOSH and/or MOAH and a distillate having an elevated content of MOSH and/or MOAH, compared to the vegetable liquid oil that is subjected to the short-path evaporation.

Method DIN EN 16995:2017 (as part of CEN/TC275/WG 13) is the method that is used to measure the content of MOSH as well as the content of MOAH.

The “content of MOSH” is defined as the total amount of saturated hydrocarbons (MOSH) with a carbon chain length in a range of C10 to C50.
The “content of MOAH” is defined as the total amount of aromatic hydrocarbons (MOAH) with a carbon chain length in a range of C10 to C50.

The process according to the invention results in a retentate vegetable liquid oil having a content of MOSH and/or MOAH that is reduced for at least 25%, at least 30%, at least 40%, at least 50%, at least 55%, at least 60%, at least 65%, at least 70% or even at least 80%, compared to the vegetable liquid oil that is subjected to the short-path evaporation while maintaining a yield of the retentate vegetable liquid oil in a range of more than 75%, more than 80%, more than 90%, more than 95%, or even more than 97%. The yield is expressed as the ratio of the amount of retentate vegetable liquid oil that is obtained versus the amount of vegetable liquid oil that was subjected to the short-path evaporation.

In a preferred aspect of the invention, the short-path evaporation of the current invention allows obtaining a reduction of MOSH and/or MOAH content of the retentate vegetable liquid oil may be obtained in a range of from 80 to 85%, while the yield is in a range of from 99.0 to 99.9%.

Additionally, the retentate vegetable liquid oil may have a reduced content of glycidyl esters (GE). GE are contaminants that are typically being formed as a result of the oils being exposed to high temperatures during oil processing, especially during deodorization. The GE content of the retentate vegetable liquid oil is below 1.0 ppm, below 0.8 ppm, below 0.5 ppm, below 0.3 ppm, below 0.1 ppm, or below LOQ (limit of quantification). The content of GE is measured with Method DGF Standard Methods Section C (Fats)C-VI 18(10).

### Further Treatment

In another aspect of the invention, the process is characterized in that it is comprising a further treatment with sparge steam of the MOSH and/or MOAH-reduced retentate vegetable liquid oil obtained from the short-path evaporation.

The further treatment with sparge steam may be performed in equipment commonly known for treatment with sparge steam, such as, but not limited to, a deodorizer unit, a stripping unit, or a collection tray.

The further treatment with sparge steam is carried out at a temperature below 260° C., below 240° C., or below 220° C.

The further treatment with sparge steam is carried out in the presence of sparge steam in an amount of from 0.1 to 2.0 wt %, from 0.2 to 1.8 wt %, or from 0.3 to 1.5 wt %, based on amount of oil.

Furthermore, the further treatment with sparge steam is carried out for a period of time of from 5 to 120 min, from 10 to 90 min, from 20 to 60 min, or from 30 to 45 min.

The further treatment with sparge steam in the present process may result in a further improvement of the flavour of the retentate vegetable liquid oil. The refined vegetable liquid oil after further treatment with sparge steam has an overall flavour quality score (taste), according to AOCS method Cg 2-83, in a range of from 7 to 10, or from 8 to 10 or from 9 to 10 (with 10 being an excellent overall flavour quality score and 1 being the worst score).

In one preferred aspect, the further treatment with sparge steam in the present process is carried out at a temperature below 220° C., below 210° C., or below 190° C., from 130 to 210° C., or from 150 to 185° C. This further refining at a temperature below 220° C. may result in a retentate vegetable liquid oil that is reduced in MOSH and/or MOAH, and that has a reduced content of GE, and that has a taste that is acceptable to good. The GE content of the retentate vegetable liquid oil is below 1 ppm, below 0.8 ppm, below 0.5 ppm, below 0.3 ppm, below 0.1 ppm, or below LOQ (limit of quantification). The retentate vegetable liquid oil after further treatment with sparge steam has an overall flavour quality score (taste), according to AOCS method Cg 2-83, in a range of from 7 to 10, or from 8 to 10 or from 9 to 10 (with 10 being an excellent overall flavour quality score and 1 being the worst score).

In one aspect of the invention, the process for reducing the content of MOSH and/or MOAH from a vegetable liquid oil is comprising the step of subjecting a vegetable oil to a short-path evaporation, wherein the short-path evaporation is performed at a pressure of below 1 mbar, at a temperature in a range of from 200 and 300° C., and with a feed rate per unit area of evaporator surface of the shorth-path evaporation equipment in a range of from 30 to 220 kg/h·m², and and thus obtaining a MOSH and/or MOAH-reduced retentate vegetable liquid oil, wherein the vegetable liquid oil is a degummed, bleached and deodorized oil.

In a specific aspect of the invention, the process for reducing the content of MOSH and/or MOAH from a vegetable liquid oil is comprising the step of subjecting a vegetable oil to a short-path evaporation, wherein the short-path evaporation is performed at a pressure of below 1 mbar, at a temperature in a range of from 200 and 300° C., and with a feed rate per unit area of evaporator surface of the shorth-path evaporation equipment in a range of from 30 to 220 kg/h·m², and and thus obtaining a MOSH and/or MOAH-reduced retentate vegetable liquid oil, wherein the vegetable oil is a degummed, bleached and deodorized, and wherein the MOSH and/or MOAH-reduced retentate vegetable liquid oil is further treated with sparge steam.

In a more specific aspect of the invention, the process for reducing the content of MOSH and/or MOAH from a vegetable liquid oil is comprising the step of subjecting a vegetable oil to a short-path evaporation, wherein the short-path evaporation is performed at a pressure of below 1 mbar, at a temperature in a range of from 200 and 300° C., and with a feed rate per unit area of evaporator surface of the shorth-path evaporation equipment in a range of from 30 to 220 kg/h·m², and

and thus obtaining a MOSH and/or MOAH-reduced retentate vegetable liquid oil,
wherein the vegetable oil is a degummed, bleached and deodorized, and
wherein the MOSH and/or MOAH-reduced retentate vegetable liquid oil is further treated with sparge steam at a temperature below 220° C., below 215° C., below 210° C., below 200° C., below 190° C., below 185° C., below 180° C., from 130 to 215° C., or from 150 to 185° C.

### The Use of a Short-Path Evaporation

The present invention further relates to the use of short-path evaporation performed at a pressure below 1 mbar, at an evaporator temperature of from 200 to 300° C., and a feed rate per unit area of evaporator surface of the shorth-path evaporation equipment in a range of from 30 to 220 kg/h·m², for reducing the content of MOSH and/or MOAH from a vegetable liquid oil.

The current invention relates to the use, wherein the short-path evaporation is performed preferably at a pressure below 0.05 mbar, more preferably below 0.01 mbar, most preferably below 0.001 mbar.

The current invention relates to the use, wherein the short-path evaporation is performed at an evaporator temperature of from 200° C. to 300° C., from 210 to 290° C., from 220 to 280° C., or from 230° C. to 270° C.

The current invention relates to the use, wherein the short-path evaporation is performed with a feed rate per unit area of evaporator surface of the shorth-path evaporation equipment in a range of from 30 to 220 kg/h·m², from 50 to 200 kg/h·m², or from 70 to 180 kg/h·m².

The current invention relates to use wherein the content of MOSH and/or MOAH in the retentate vegetable liquid oil is reduced for at least 25%, at least 30%, at least 40%, at least 50%, at least 55%, at least 60%, at least 70% or even at least 80% while maintaining a yield of the retentate vegetable liquid oil in a range of more than 75%, more than 80%, more than 90%, more than 95%, or even more than 97%.

### EXAMPLES

### 1. Starting Material

Refined, bleached and deodorized (RBD) sunflower oil was spiked with 125 ppm of a master-mix based on lubricants, lube sprays and used engine oil containing MOSH-MOAH. Table 1 describes the composition of the MOAH-MOAH master-mix.

TABLE 1
MOAH-MOAH master-mix

| Lubricants & used engine oil | Part |
|---|---|
| Cassida Fluid HF 46 | 1 |
| Cassida Fluid HF 15 | 1 |
| Rivolta TRS Plus Spray | 1 |
| Rivolta SKS 48 | 1 |
| Panreco Drageol | 1 |
| Used engine oil - 15W40 | 3 |

### 2. SPE Conditions

Short-Path Evaporation (SPE) Unit KDL-5 from UIC was used for the short-path evaporation. The KDL-5 unit has an evaporator surface of 0.048 m²

The following conditions were applied:
Feed-temperature: 80° C.
Evaporation Temp.: 250° C.
Condenser Temp.: 70° C.
Distillate Temp.: 70° C.
Retentate Temp.: 150° C.
Wiper speed: 366 rpm
Pressure: below 10⁻³ mbar
Feed rate in KDL-5: 1.26 liter/h

Conversion of applied feed rates in KDL-5 SPE Unit (in liter/hour) to feed rate in a KD-10 industrial SPE Unit from IUC (in kg/h), and further conversion to the feed rate per unit area of evaporator surface of the shorth-path evaporation equipment (in kg/h·m²) for industrial scale short-path evaporation equipment is shown in table 2.

TABLE 2
Conversion of applied feed rates

| | | Feed rate per unit area of |
|---|---|---|
| | | evaporator surface of the |
| | | shorth-path evaporation |
| | Corre- | equipment (Specific |
| | sponding | throughput) (in kg/h · m2) |
| Feed rate | Feed rate | for industrial scale short- |
| in KDL-5 | in KD-10 | path evaporation |
| (in liter/h) | (in kg/h) | equipment |
| 1.26 | 15.76 | 157.6 |

Thus, the example is conducted according to the specifications of the claims.

### 3. Results

MOSH and MOAH content of the oils was analyzed for the spiked RBD oils before the SPE treatment (=starting material of test) and after (=retentate of test). The yield of the retentate vegetable liquid oil was calculated based on the amount of retentate vegetable liquid oil after SPE treatment versus the amount of spiked RBD oil before the SPE treatment. The results are shown in Table 3 for RBD sunflower oil.

TABLE 3
Results

| | | | | | MOSH + | | |
|---|---|---|---|---|---|---|---|
| | MOSH | | MOAH | | MOAH | | Retentate |
| | C10-C50 | | C10-C50 | | C10-C50 | | yield |
| Starting | 108 | ppm | 4.6 | ppm | 112.6 | ppm | |
| material | | | | | | | |
| RBD | | | | | | | |
| sunflower | | | | | | | |
| oil) | | | | | | | |
| Retentate | 17.5 | ppm | 2.1 | ppm | 19.6 | ppm | 100% |

| | | |
|---|---|---|
| Reduced | Reduced | Reduced |
| with 84% | with 54% | with 83% |

1. A process for reducing the content of MOSH and/or MOAH from a vegetable liquid oil, wherein the process comprises: subjecting a vegetable liquid oil to a short-path evaporation to obtain a retentate
vegetable liquid oil and a distillate, wherein the short-path evaporation is performed at a pressure of below 1 mbar, at an evaporator temperature in a range of from 200° C. to 300° C., and with a feed rate per unit area of evaporator surface of the shorth-path evaporation equipment in a range of from 30 to 220 kg/h·m².

2. The process according to claim 1, wherein the short-path evaporation is performed at a pressure below 0.01 mbar.

3. The process according to claim 1, wherein the vegetable liquid oil is a degummed, bleached and/or deodorized vegetable liquid oil.

4. The process according to claim 1, wherein the vegetable liquid oil is at least degummed.

5. The process according to claim 1, wherein the process is comprising a further treatment with sparge steam of the MOSH and/or MOAH-reduced retentate vegetable liquid oil.

6. (canceled)

7. The process according to claim 1, wherein the short-path evaporation is performed at a pressure below 0.001 mbar.

8. The process according to claim 1, wherein the distillate has an elevated content of MOSH and/or MOAH compared to the vegetable liquid oil that is subjected to the short-path evaporation.

9. The process according to claim 1, wherein the content of MOSH and/or MOAH in the retentate vegetable liquid oil is reduced by at least 25 to 80%, and the yield of the retentate vegetable liquid oil is more than 75%.

10. The process according to claim 5, wherein the treatment with sparge steam is carried out at a temperature below 220° C.

11. The process according to claim 5, wherein the treatment with sparge steam is carried out in an amount from 0.1 to 2.0 wt % based on amount of the retentate vegetable liquid oil.

12. The process according to claim 5, wherein the treatment with sparge steam results in a flavour quality score according to AOCS method Cg 2-83 of from 7 to 10 for the retentate vegetable liquid oil.

13. The process according to claim 1, wherein the feed rate per unit area of evaporator surface of the short-path evaporation equipment is in a range from 70 to 180 kg/h·m².

14. The process of claim 1, wherein the glycidyl ester content of the retentate vegetable liquid oil is below 1.0 ppm.
